(19) United States
(12) Patent Application Publication
(10) Pub. No.: US 2024/0030714 A1
(43) Pub. Date: Jan. 25, 2024

(54) Power Storage System And Equalizing Charge Method

(71) Applicants: Furukawa Electric Co., Ltd., Tokyo (JP); The Furukawa Battery Co., Ltd., Yokohama (JP)

(72) Inventors: Hideto Nakamura, Tokyo (JP); Masanobu Aragaki, Tokyo (JP); Akira Tanaka, Tokyo (JP); Toshiyuki Sato, Yokohama (JP)

(21) Appl. No.: 18/478,138

(22) Filed: Sep. 29, 2023

Related U.S. Application Data
(63) Continuation of application No. PCT/JP2022/003400, filed on Jan. 28, 2022.

(30) Foreign Application Priority Data
Mar. 30, 2021 (JP) 2021-057386

(51) Int. Cl. H02J 3/32; H02J 7/00; H02P 9/02; H02J 3/38

(52) U.S. Cl. CPC H02J 3/32; H02J 7/0014; H02J 7/0048; H02P 9/02; H02J 3/38; H02J 2300/24; H02J 2207/20

(57) ABSTRACT

A power storage system and an equalizing charge method capable of performing equalizing charging more efficiently are provided. In the power storage system, a plurality of assembled storage batteries connected to an external power supply system including rotary machine power generation and solar power generation are charged with surplus power in daytime generated by the rotary machine power generation and the solar power generation to store the surplus power and are discharged according to insufficient power generation by the rotary machine power generation to handle the insufficient power generation. An equalizing charging operation is performed on one or two or more assembled storage batteries selected from the plurality of assembled storage batteries at time of charging with the surplus power when it is determined that equalizing charging is required.

### CROSS-REFERENCE TO RELATED APPLICATION(S)

This application is a continuation of PCT Application No. PCT/JP2022/003400, filed Jan. 28, 2022, which claims priority to Japanese Patent Application No. 2021-057386, filed Mar. 30, 2021, each disclosure of which is incorporated herein in its entirety by reference.

### TECHNICAL FIELD

The present invention relates to a power storage system and an equalizing charge method in the power storage system.

### BACKGROUND

As a conventional power storage system (i.e., a power storage apparatus, a power storage device) having a plurality of assembled storage batteries and an equalizing charge method in the power storage system, for example, there are technologies described in JP Patent Publication No. 2019-154108 A and JP Patent Publication No. 2019-154109 A.

JP Patent Publication No. 2019-154108 A and JP Patent Publication No. 2019-154109 A describe that a large amount of power is required to perform equalizing charging on all of a plurality of assembled storage batteries constituting a power storage system, and electric power is exchanged between the plurality of assembled storage batteries as equalizing charging operation.

However, there is a problem that an assembled storage battery other than assembled storage batteries on which the equalizing charging is performed does not necessarily store power necessary for the equalizing charging.

In addition, when power is exchanged between a plurality of assembled storage batteries, it is necessary to repeat charging and discharging between the assembled storage batteries. However, because the conversion efficiency at the time of charging and discharging between the storage batteries is relatively lower than the conversion efficiency at the time of charging external power, there is a problem that the efficiency of charging and discharging decreases in the equalizing charge methods described in JP Patent Publication No. 2019-154108 A and JP Patent Publication No. 2019-154109 A. For example, when a storage battery is directly charged with external power, the conversion efficiency exceeds 90%, but when the storage battery is charged and discharged from another assembled storage battery, the conversion efficiency is lower than 80%.

### SUMMARY

The present invention has been made in view of the above points, and provides a power storage system and an equalizing charge method capable of performing equalizing charging more efficiently than before.

In a case where an external power supply system includes solar power generation, as the introduction of solar power generation progresses and the amount of power generated by solar power generation increases, power generation in the daytime by rotary machine power generation that generates power using a power generator such as thermal power generation, nuclear power generation, or hydraulic power generation becomes unnecessary, and the output of the rotary machine power generation can be suppressed. However, it is difficult to suppress the output of the rotary machine power generation to the minimum output or less. In view of this, there is a power storage system that stores surplus power generated in response to power generation by solar power generation and rotary machine power generation in the daytime in a storage battery. In addition, although the output of the rotary machine power generation is suppressed in the daytime as described above, because power is not supplied from the solar power generation after the evening, the demand for power of the rotary machine power generation rapidly increases. However, the rotary machine power generation cannot sharply increase power generation at an increase rate equal to or higher than the maximum output gradient. The power storage system can handle the insufficient power generation by discharging from the storage battery.

Focusing on such a fact, the present inventor has made the present invention by considering that, at the time of charging a storage battery with surplus power in the daytime, equalizing charging is also performed according to a requirement for the equalizing charging.

In order to solve the problem, according to one aspect of the present invention, a power storage system includes: a plurality of assembled storage batteries each configured by electrically connecting a plurality of storage batteries; a plurality of AC-DC converters provided for each of the assembled storage batteries and electrically connecting an external power supply system including rotary machine power generation and solar power generation to the assembled storage batteries; a plurality of individual assembled storage battery management units provided for each of the assembled storage batteries and configured to manage states of the assembled storage batteries and control the AC-DC converters to charge and discharge the assembled storage batteries; an upper assembled storage battery management unit configured to acquire a state of each of the assembled storage batteries from the plurality of individual assembled storage battery management units and supply a charge/discharge command to each of the individual assembled storage battery management units; and an equalizing charging necessity determination unit configured to determine whether or not equalizing charging needs to be performed; wherein the upper assembled storage battery management unit includes: a charge processing unit configured to control a charging operation of charging the plurality of assembled storage batteries with surplus power in daytime generated by the solar power generation and the rotary machine power generation; and a discharge processing unit configured to control an operation of discharging the plurality of assembled storage batteries according to insufficient power generation by the rotary machine power generation, and when the equalizing charging necessity determining unit determines that the equalizing charging needs to be performed, the charge processing unit performs control for an equalizing charging operation on one or two or more of the assembled storage batteries selected from the plurality of assembled storage batteries by using the surplus power.

According to another aspect of the present invention, an equalizing charge method includes performing an equalizing charging operation on one or two or more assembled storage batteries selected from a plurality of assembled storage batteries at a time of charging with surplus power when it is determined that equalizing charging is required in a power storage system in which the plurality of assembled storage batteries connected to an external power supply system including rotary machine power generation and solar power generation are charged with the surplus power in daytime generated by the solar power generation and the rotary machine power generation to store the surplus power and are discharged according to insufficient power generation by the rotary machine power generation to handle the insufficient power generation.

According to an aspect of the present invention, the assembled storage batteries are charged with surplus power in the daytime generated by the solar power generation and the rotary machine power generation, an operation of discharging from the assembled storage batteries is performed according to insufficient power generation by the rotary machine power generation, and the equalizing charging is performed at the time of the charging.

According to this configuration, because the equalizing charging can be performed with the surplus power, it is possible to perform the equalizing charging more efficiently than before.

In this case, the plurality of assembled storage batteries may be divided into a plurality of storage battery groups, and control for the equalizing charging operation may be performed on a storage battery group selected from the plurality of storage battery groups.

According to this configuration, it is possible to more reliably perform the equalizing charging at the time of charging with the surplus power by performing the equalizing charging only on some assembled storage batteries without simultaneously performing the equalizing charging on all the plurality of the assembled storage batteries.

In this case, when it is determined that there is a margin in the surplus power during constant voltage (CV) charging as the equalizing charging operation on the selected storage battery group, a charging/discharging operation may be performed on a storage battery group selected from the storage battery groups other than the storage battery group being subjected to the equalizing charging with the surplus power corresponding to the margin.

In this case, it is possible to perform the charging with the surplus power more efficiently.

### BRIEF DESCRIPTION OF THE DRAWINGS

FIG. 1 is a diagram illustrating a configuration of a power storage system according to an embodiment of the present invention.

FIG. 2 is a diagram illustrating a configuration example of an upper battery management unit (BMU).

FIG. 3 is a diagram illustrating a configuration example of individual BMUs.

FIG. 4 is a diagram illustrating an example of a process flow for an equalizing charging operation.

FIG. 5 is a diagram for explaining an example of occurrence of a charging operation and a discharging operation.

FIG. 6 is a diagram illustrating an example of surplus power over time.

FIG. 7 is a diagram illustrating a process of an equalizing charging operation based on the process illustrated in FIG. 4.

FIG. 8 is a diagram illustrating a processing example at the time of each operation based on the process illustrated in FIG. 4.

FIG. 9 is a diagram illustrating a process of an equalizing charging operation.

FIG. 10 is a diagram illustrating an example in which equalizing charging is required.

FIG. 11 is a diagram illustrating an example of another process flow for an equalizing charging operation.

FIG. 12 is a diagram illustrating a process of an equalizing charging operation based on the process illustrated in FIG. 10.

FIG. 13 is a diagram illustrating a processing example at the time of each operation based on the process illustrated in FIG. 10.

### DETAILED DESCRIPTION

Next, embodiments of the present invention are described with reference to the drawings.

Here, the same components are described with the same reference signs unless otherwise noted. In each drawing, the thickness and ratio of each component may be exaggerated, and the number of components may also be illustrated differently from those of the actual product. The present invention is not limited to the following embodiments as they are, and can be embodied by appropriate combinations or modifications without departing from the gist of the present invention, and forms in which such changes or improvements are added can also be included in the present invention.

In the following description, processing of a portion related to equalizing charging will be mainly described.

Configuration

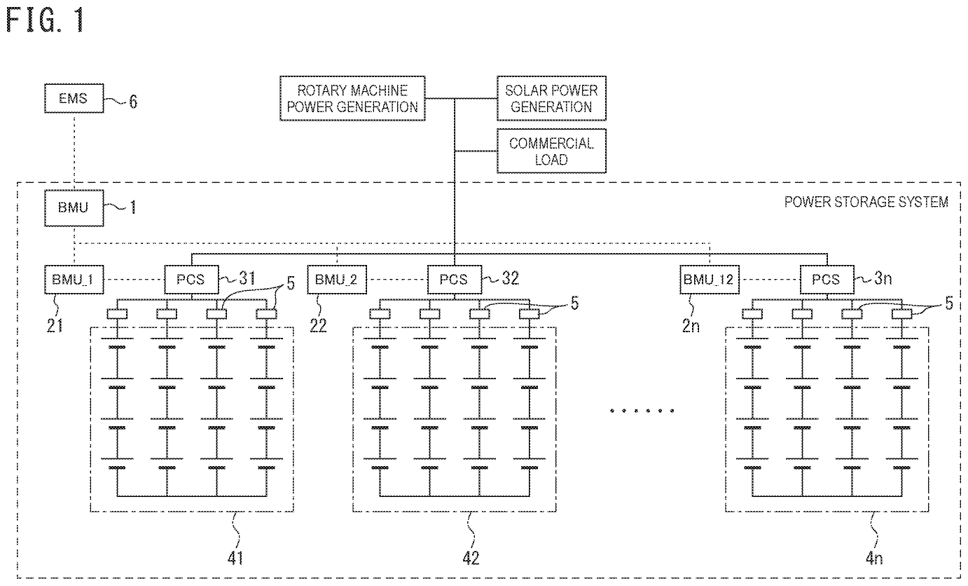

As illustrated in FIG. 1, a power storage system of the present embodiment includes a plurality of assembled storage batteries 41 to 4n, a plurality of power conversion systems (PCSs) 31 to 3n, individual storage battery management units (BMUs) 21 to 2n, an upper storage battery management unit (BMU) 1, and an equalizing charging necessity determination unit (EMS) 6.

Assembled Storage Batteries 41 to 4n

Each of the assembled storage batteries 41 to 4n is configured by electrically connecting a plurality of bipolar type lead-acid batteries. Each of the assembled storage batteries 41 to 4n illustrated in FIG. 1 is configured by connecting a plurality of strings in parallel. Each of the strings is configured by connecting a plurality of bipolar lead-acid batteries in series. In FIG. 1, an assembled storage battery sensor 5 is provided for each of the strings and acquires battery information such as a voltage in the corresponding string. The assembled storage battery sensors 5 supply the acquired information to the corresponding individual BMUs 21 to 2n.

In the following description, a case where the number of the plurality of assembled storage batteries 41 to 4n is 12 will be described as an example. However, the number of the plurality of assembled storage batteries 41 to 4n is not limited to 12. Because the assembled storage batteries 41 to 4n are charged and discharged by the PCSs 31 to 3n, the 12 assembled storage batteries 41 to 4n to be charged and discharged may be represented by PCSs 1 to 12 in the following description.

PCSs 31 to 3n

Each of the PCSs 31 to 3n is an AC-DC converter, and is individually provided for a respective one of the assembled storage batteries 41 to 4n. The PCSs 31 to 3n electrically connect an external power supply system including rotary machine power generation and solar power generation to the corresponding assembled storage batteries 41 to 4n, and perform AC-DC conversion processing to charge and discharge the corresponding assembled storage batteries 41 to 4n.

EMS 6

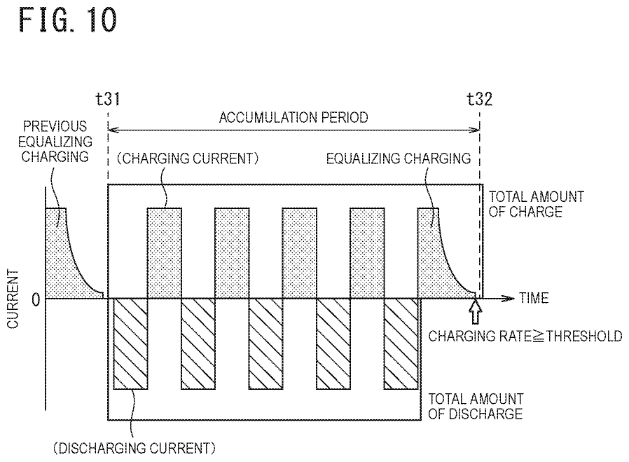

The EMS 6 performs charge/discharge control of all the plurality of assembled storage batteries 41 to 4n based on a command from the outside of the power storage system. The EMS 6 includes an equalizing charging necessity determination unit. The equalizing charging necessity determination unit determines whether equalizing charging needs to be performed. For example, as illustrated in FIG. 10, the equalizing charging necessity determination unit determines whether equalizing charging is required, based on the number of days elapsed from the previous equalizing charging and the state of charging. The determination as to whether equalizing charging is required may be performed by other methods. The upper BMU 1 or the like may have the equalizing charging necessity determination unit.

Individual BMUs 21 to 2n

Each of the individual BMUs 21 to 2n is provided for a respective one of the assembled storage batteries 41 to 4n. The individual BMUs 21 to 2n manage states of the corresponding assembled storage batteries 41 to 4n and control the PCSs 31 to 3n to charge and discharge the corresponding assembled storage batteries 41 to 4n. Specifically, the individual BMUs 21 to 2n determine the states (states, alarms) of the storage batteries, notify the upper BMU 1 of the states, and control the corresponding PCSs 31 to 3n based on a charge/discharge command from the upper BMU 1.

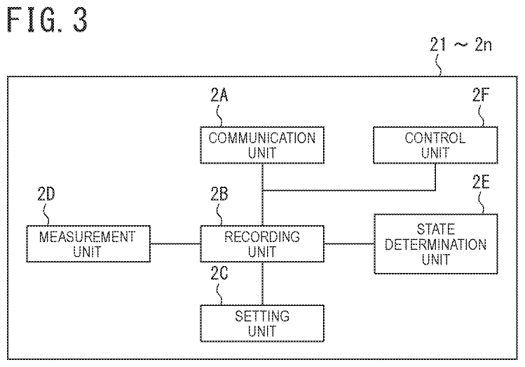

The individual BMUs 21 to 2n have, for example, a configuration illustrated in FIG. 3. In this example, each of the individual BMUs 21 to 2n includes a communication unit 2A, a recording unit 2B, a setting unit 2C, a measurement unit 2D, a state determination unit 2E, and a control unit 2F.

The communication unit 2A transmits state determination information and alarm information to the upper BMU 1 and receives a charge/discharge command value.

The recording unit 2B stores a setting condition, a measurement result, a state determination result, and the like.

The setting unit 2C performs various settings such as a determination threshold.

The measurement unit 2D collects measurement information from sensors such as the assembled storage battery sensor 5 and a temperature sensor (not illustrated).

The state determination unit 2E performs control determination related to state determination, alarm determination, and equalizing charging on the storage battery using information from the measurement result.

The control unit 2F controls the corresponding PCSs 31 to 3n on the basis of a charge/discharge command from the upper BMU 1. Further, when the equalizing charging operation is required, the PCSs 31 to 3n are controlled based on the result of the state determination unit 2E.

Note that, in this configuration example, information is transmitted and received via the recording units 2B.

Upper BMU 1

The upper BMU 1 acquires a state of each of the assembled storage batteries 41 to 4n from the individual BMUs 21 to 2n, and supplies a charge/discharge command to each of the individual BMUs 21 to 2n. Specifically, the upper BMU 1 converts information from each of the individual BMUs 21 to 2n into information of the entire storage battery and notifies the EMS 6 of the information, assigns a charge/discharge command from the EMS 6 to each of the individual BMUs 21 to 2n, and performs processing of determining the individual BMUs 21 to 2n for performing equalizing charging.

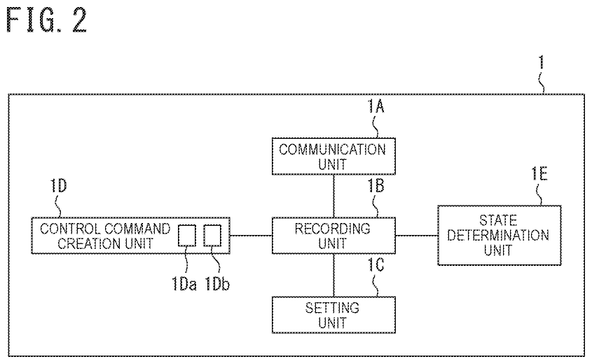

The upper BMU 1 has, for example, a configuration illustrated in FIG. 2. In this example, the upper BMU 1 includes a communication unit 1A, a recording unit 1B, a setting unit 1C, a control command creation unit 1D, and a state determination unit 1E.

The communication unit 1A transmits the state determination information and the alarm information to the EMS 6, receives the charge/discharge command value, and transmits a control command value to each of the individual BMUs 21 to 2n.

The recording unit 1B stores a setting condition, a measurement result, a state determination result, and the like.

The setting unit 1C performs various settings such as a determination threshold.

The control command creation unit 1D creates a control command to each of the individual BMUs 21 to 2n on the basis of a control command from the EMS 6.

The state determination unit 1E creates storage battery information of the entire power storage system from storage battery information of the individual BMUs 21 to 2n.

The control command creation unit 1D of the present embodiment includes a charge processing unit 1Da and a discharge processing unit 1Db.

The charge processing unit 1Da creates a command for controlling a charging operation of charging the plurality of assembled storage batteries 41 to 4n with surplus power (hereinafter, it is also simply referred to as surplus power) generated by the power generation of the solar power generation and the rotary machine power generation in the daytime, and supplies the command to the individual BMUs 21 to 2n.

The discharge processing unit 1Db creates a command for controlling an operation of discharging the plurality of assembled storage batteries 41 to 4n and supplies the command to the individual BMUs 21 to 2n in order to handle insufficient power generation by the rotary machine power generation.

In addition, when the equalizing charging necessity determination unit of the EMS 6 determines that the equalizing charging needs to be performed, and determines that there is surplus power with which equalizing charging can be performed, the charge processing unit 1Da creates a command for performing control for the equalizing charging operation with the surplus power for one or two or more of the assembled storage batteries 41 to 4n selected from the plurality of the assembled storage batteries 41 to 4n, and supplies the command to the corresponding individual BMUs 21 to 2n. This processing constitutes an equalizing charging processing unit.

Here, in the present embodiment, the plurality of (12 in the present example) assembled storage batteries 41 to 4n are divided into a plurality of storage battery groups. In this embodiment, an example is described in which each of the groups is constituted by four assembled storage batteries, and the assembled storage batteries are classified into three storage battery groups (PCSs 1 to 4, PCSs 5 to 8, PCSs 9 to 12). The number of storage battery groups to be obtained by the classification is preferably two or three. Although they may be divided into four or more, waste occurs in processing.

Then, when the equalizing charging necessity determination unit of the EMS 6 determines that the equalizing charging needs to be performed, the charge processing unit 1Da of the present embodiment creates a command for performing control for the equalizing charging operation on a storage battery group selected from the plurality of storage battery groups.

In this case, the charge processing unit 1Da performs control for the equalizing charging operation on one storage battery group selected from the plurality of storage battery groups, and when it is determined that there is a margin in the surplus power during the CV charging as the equalizing charging operation on the selected storage battery group, the charge processing unit 1Da creates a command for performing the charge operation on a storage battery group selected from the storage battery groups other than the selected storage battery group with the surplus power corresponding to the margin.

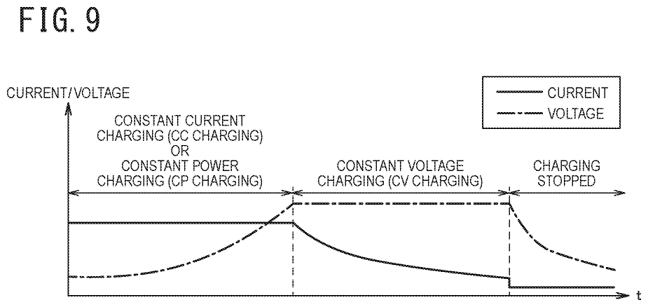

Here, as illustrated in FIG. 9, the equalizing charging is performed on the target assembled storage batteries 41 to 4n through a process of charging by CC charging or CP charging and CV charging. Specifically, CC charging or CP charging is performed until the voltages of the assembled storage batteries subjected to the equalizing charging reach a starting threshold voltage, and when the voltages of the assembled storage batteries subjected to the equalizing charging become equal to or higher than the starting threshold voltage, the process shifts to CV charging.

In the following description, the charging process is defined as follows.

Charging with surplus power: Charging with surplus power is performed (charging with power corresponding to “surplus power−maximum charging” is performed).

Maximum charging: Charging with the maximum amount of power that can be converted by the PCSs 31 to 3n is performed.

CV charging: Charging with a constant voltage is performed.

Constant Power (CP) charging: Charging with constant power is performed.

CV charging assist control: Charging control is performed to control charging with power corresponding to “surplus power−(CV charging+maximum charging)”.

However, in the CV charging assist control, when it is determined that the surplus power<CV charging (equalizing charging), power corresponding to (power for CV charging−surplus power) is discharged.

In addition, the equalizing charging is performed on one storage battery group selected from the first to third storage battery groups, and each time it is determined that the equalizing charging is required, the storage battery groups to be subjected to equalizing charging are changed in order according to a preset rule.

For example, first to third numbers are allocated to the three storage battery groups, and the first to third storage battery groups are shifted and changed in order every time equalizing charging is performed.

For example, regarding the 12 assembled storage batteries, the PCSs 1 to 4 are a first storage battery group, the PCSs 5 to 8 are a second storage battery group, and the PCSs 9 to 12 are a third storage battery group. Then, each time the equalizing charging is started, each of the assembled storage batteries 41 to 4n constituting the first to third storage battery groups is changed. For example, at the time of the next equalizing charging, the order is changed such that the PCSs 5 to 8 are a first storage battery group, the PCSs 9 to 12 are a second storage battery group, and the PCSs 1 to 4 are a third storage battery group.

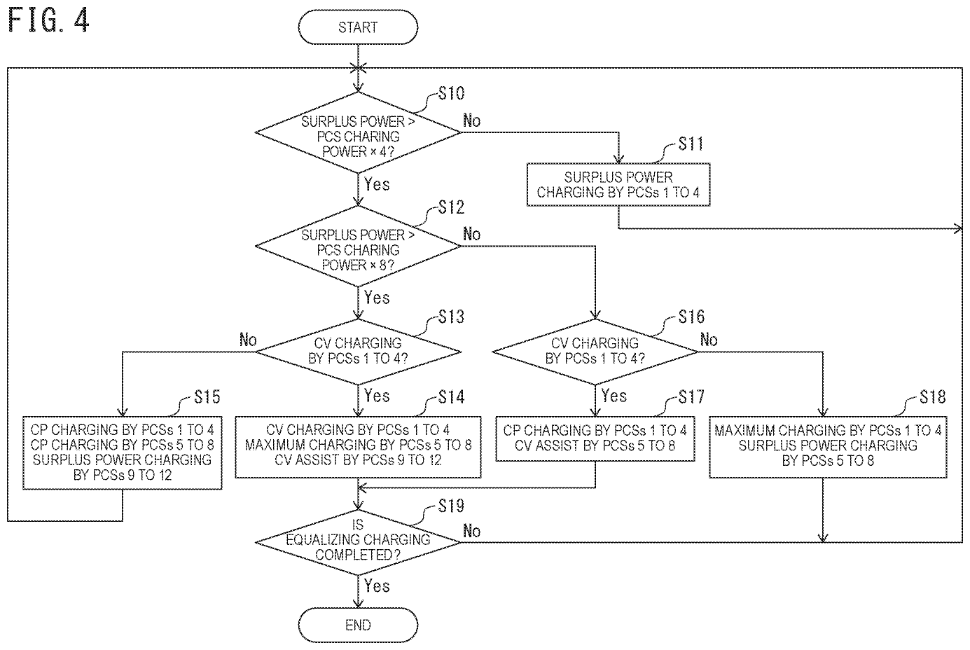

The charging processing (creation of a command) when it is determined that equalizing charging is required in the charge processing unit 1Da is performed by the process illustrated in FIG. 4 at a predetermined sampling period.

Note that the equalizing charging processing is performed at daytime when solar power generation is performed, and an initialization process is performed before a process of each equalizing charging operation.

First, in step S10, it is determined whether or not the surplus power in the daytime is greater than charging power to the four assembled storage batteries constituting the first storage battery group. Then, in a case where it is greater than the charging power to the four assembled storage batteries and the determination is satisfied, the process proceeds to step S12. On the other hand, in a case where it is less than the charging power to the four assembled storage batteries and the determination is not satisfied, the process proceeds to step S11.

When it is determined that the surplus power is less than the charging power to the four assembled storage batteries and the process proceeds to step S11, a command for performing surplus power charging for charging with the surplus power is output to the four assembled storage batteries constituting the first storage battery group in step S11, and the process proceeds to step S10.

In addition, when it is determined that the surplus power is greater than the charging power to the four assembled storage batteries and the process proceeds to step S12, the equalizing charging operation is enabled, and it is determined whether the surplus power is greater than charging power to the eight assembled storage batteries constituting the first storage battery group and the second storage battery group in step S12. In a case where it is greater than the charging power to the eight assembled storage batteries and the determination is satisfied, the process proceeds to step S13. On the other hand, in a case where it is greater than the charging power to the four assembled storage batteries but is less than the charging power to the eight assembled storage batteries and the determination is not satisfied, the process proceeds to step S16.

When it is determined that the surplus power is greater than the charging power to the eight assembled storage batteries and the process proceeds to step S13, it is determined whether or not a condition for transition to CV charging is satisfied as the process of the equalizing charging operation of charging the four assembled storage batteries constituting the first storage battery group in step S13. In a case where the transition condition is satisfied, the process proceeds to step S14. In a case where the transition condition is not satisfied, the process proceeds to step S15.

In step S14, a command for CV charging is supplied to the four assembled storage batteries 41 to 4n constituting the first storage battery group, a command for maximum charging is supplied to the four assembled storage batteries 41 to 4n constituting the second storage battery group, a command for CV charging assist control is supplied to the four assembled storage batteries 41 to 4n constituting the third storage battery group, and the process proceeds to step S19.

In step S19, it is determined whether the equalizing charging has been completed. When it is determined that the equalizing charging has been completed, the process of the equalizing charging operation is ended. On the other hand, when the equalizing charging is not completed, the process proceeds to step S10.

In the determination of the end of the equalizing charging, for example, an end condition in which the time of CV charging is equal to or longer than a threshold value, the charging current is equal to or less than a threshold value, or the charging rate is equal to or higher than a threshold value is set, and when it is determined that the end condition is satisfied, it is determined that the equalizing charging has been ended.

In step S15, a command for maximum charging in CP charging is supplied to the four assembled storage batteries 41 to 4n constituting the first storage battery group, a command for maximum charging in CP charging is supplied to the four assembled storage batteries 41 to 4n constituting the second storage battery group, a command for surplus power charging is supplied to the assembled storage batteries 41 to 4n constituting the third storage battery group, and the process proceeds to step S10.

When the surplus power is greater than the charging power to the four assembled storage batteries constituting the first storage battery group but is less than the charging power to the eight assembled storage batteries constituting the first and second storage battery groups, the process proceeds to step S16, and it is determined whether the condition for transition to CV charging is satisfied as the process of the equalizing charging operation on the four assembled storage batteries constituting the first storage battery group in step S16. When the transition condition is satisfied, the process proceeds to step S17. When the transition condition is not satisfied, the process proceeds to step S18.

In step S17, a command for CV charging is supplied to the four assembled storage batteries 41 to 4n constituting the first storage battery group, and a command for processing of CV charging assist control is supplied to the four assembled storage batteries 41 to 4n constituting the second storage battery group, and the process proceeds to step S19.

In step S18, a command for maximum charging is supplied to the four assembled storage batteries 41 to 4n constituting the first storage battery group, and a command for surplus power charging is supplied to the four assembled storage batteries 41 to 4n constituting the second storage battery group, and the process proceeds to step S10.

Here, the upper BMU 1 constitutes an upper assembled storage battery management unit, and the individual BMUs 21 to 2n constitutes individual assembled storage battery management units.

Operation and Others

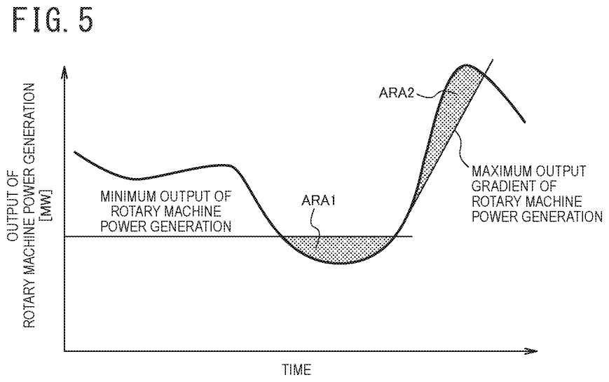

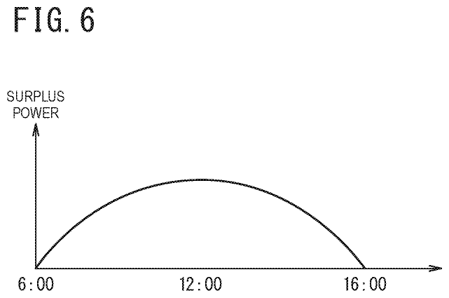

With the spread of solar power generation, a required amount of power generated by the rotary machine power generation in the daytime decreases due to the power generation of the solar power generation. However, as illustrated in FIG. 5, even if the amount of power generated by the rotary machine power generation in the daytime is reduced, it is difficult for the rotary machine power generation to reduce the amount of power to be generated to less than the minimum output, and surplus power as indicated by the reference sign ARA1 is inevitably generated. Therefore, in the daytime, as the output of the solar power generation increases, surplus power is generated in the daytime as illustrated in FIG. 6.

Note that the surplus power in the daytime is in a state similar to the reference sign ARA1 in FIG. 5, but is not in the power state indicated by the reference sign ARA1 itself. It depends on the power generation state of the solar power generation.

That is, depending on the amount of light of the sun, as time elapses, surplus power is generated in the daytime along an upwardly projecting curved shape. In the present embodiment, the plurality of assembled storage batteries 41 to 4n are charged with the surplus power in the daytime such that the surplus power in the daytime is stored in the plurality of assembled storage batteries 41 to 4n. Because this surplus power depends on the power generation of the solar power generation, it can be regarded as surplus power of the solar power generation.

On the other hand, as illustrated in FIG. 5, the rotary machine power generation cannot sharply increase the power generation amount at an increase rate equal to or higher than the maximum output gradient. On the other hand, in the present embodiment, when the demand for power generated by the rotary machine power generation sharply occurs, the power stored in the assembled storage batteries 41 to 4n is discharged (see the reference sign ARA2 in FIG. 5) to handle the sharp power demand for the rotary machine power generation. That is, because power is not generated by the solar power generation after the evening, it is necessary to cover power generation demand with the rotary machine power generation, but a rapid increase in the power generation load is handled by the discharge of the power stored in the storage batteries.

In the present embodiment, in a case where the equalizing charging is required when the assembled storage batteries 41 to 4n are to be charged with the surplus power, the equalizing charging operation is also performed using the surplus power. That is, in the present embodiment, the equalizing charging can be performed while the surplus power is stored in the assembled storage batteries 41 to 4n. For this reason, it is possible to suppress the necessity of performing the equalizing charging by charging and discharging between the storage batteries, thereby improving the efficiency of charging and discharging of the power storage system. The equalizing charging may be performed in the daytime when the weather is fine.

In this case, the control for the equalizing charging operation may be performed on some of the storage battery groups selected from the plurality of storage battery groups. In this case, the equalizing charging operation can be more reliably completed by limiting the storage battery groups to be subjected to the equalizing charging.

In addition, when it is determined that there is a margin in surplus power during CV charging as the equalizing charging operation on a selected storage battery group, the charging/discharging operation may be performed on a storage battery group selected from the storage battery groups other than the storage battery group being subjected to the equalizing charging with the surplus power corresponding to the margin.

According to this configuration, it is possible to perform the equalizing charging while efficiently performing charging using surplus power in the daytime.

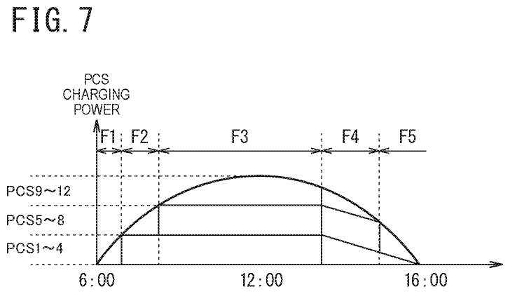

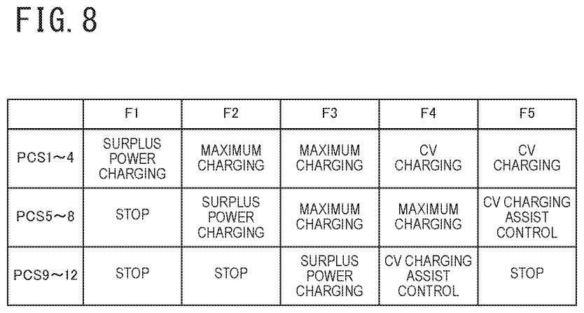

An example of an operation of the process illustrated in FIG. 4 for the equalizing charging operation by the upper BMU 1 will be described with reference to FIGS. 7 and 8.

In a region F1 in the morning, because the sunlight is weak and the surplus power is less than the charging power to the first storage battery group (PCSs 1 to 4), the processing of step S11 is performed and the processing of surplus power charging is performed on the first storage battery group. Note that this charging is not the equalizing charging operation.

Next, the time advances to a region F2, and when the surplus power becomes greater than the charging power to the first storage battery group (PCSs 1 to 4), the equalizing charging operation is started. Then, the processing of step S18 is performed, the processing of maximum charging is performed on the first storage battery group (PCSs 1 to 4), and the processing of surplus power charging is performed on the second storage battery group (PCSs 5 to 8).

Next, when the time advances to a region F3 and the surplus power further increases to reach a peak state or a state near the peak state, step S15 is performed, the processing of CP charging by the maximum charging is performed on the first storage battery group (PCSs 1 to 4) and the second storage battery group (PCSs 5 to 8), and the surplus power charging is performed on the third storage battery group (PCSs 9 to 12).

Next, when the time advances to a region F4 and the amount of power generated by the solar power generation slightly decreases, step S14 is performed, the processing of CV charging as equalizing charging is performed on the first storage battery group (PCSs 1 to 4), the processing of maximum charging is performed on the second storage battery group (PCSs 5 to 8), and CV charging assist control is performed on the third storage battery group (PCSs 9 to 12).

Next, when the time advances to a region F5 and the amount of power generated by the solar power generation further decreases, the processing of CV charging as equalizing charging is continued for the first storage battery group (PCSs 1 to 4), and the CV charging assist control is performed on the second storage battery group (PCSs 5 to 8).

In this manner, in a case where charging with the surplus power is performed, the equalizing charging is performed on the first storage battery group. Further, when the first storage battery group is subjected to CV charging in the equalizing charging operation, charge/discharge control (CV charging assist control) according to a relationship between surplus power and CV charging as equalizing charging is performed on the second storage battery group or the third storage battery group.

Modifications

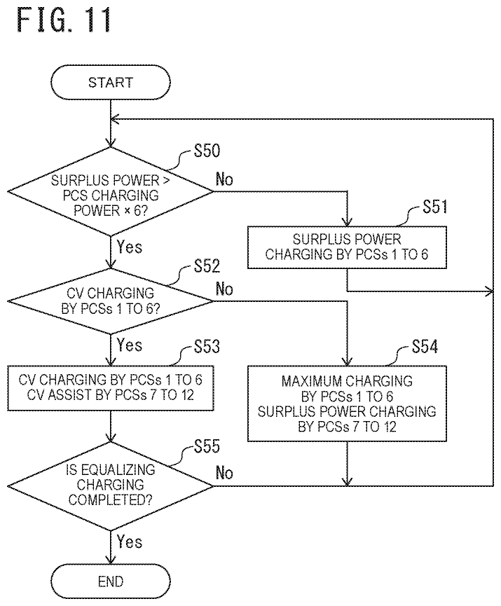

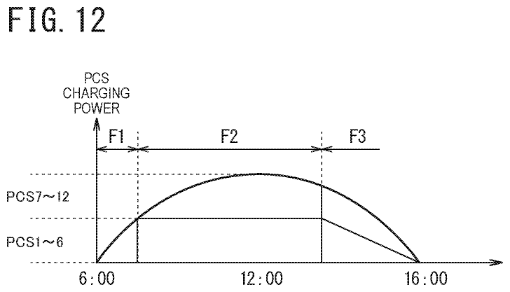

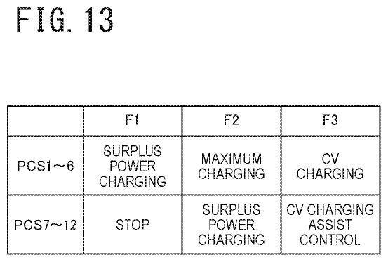

Here, FIG. 11 illustrates an example of a process flow for equalizing charging with surplus power in a case where a plurality of bipolar lead-acid batteries are classified into two storage battery groups. Further, an operation example in this case is illustrated in FIGS. 12 and 13.

In the process illustrated in FIG. 11, first, in step S50, it is determined whether or not the surplus power in the daytime is greater than charging power to six assembled storage batteries constituting a first storage battery group. Then, in a case where it is greater than the charging power to the six assembled storage batteries and the determination is satisfied, the process proceeds to step S52. On the other hand, in a case where it is less than the charging power to the six assembled storage batteries and the determination is not satisfied, the process proceeds to step S51.

When it is determined that the surplus power is less than the charging power to the six assembled storage batteries and the process proceeds to step S51, a command for performing surplus power charging for charging with the surplus power is output to the six assembled storage batteries constituting the first storage battery group in step S51, and the process proceeds to step S50. By the processing of step S51, the charging processing is performed in the region F1. Note that this charging is not the equalizing charging operation.

When it is determined that the surplus power is greater than the charging power to the six assembled storage batteries and the process proceeds to step S52, it is determined whether or not a condition for transition to CV charging is satisfied as the process of the equalizing charging operation of charging the six assembled storage batteries constituting the first storage battery group. When the transition condition is satisfied, the process proceeds to step S53. When the transition condition is not satisfied, the process proceeds to step S54.

In step S53, a command for CV charging is supplied to the six assembled storage batteries 41 to 4n constituting the first storage battery group, and a command for processing of CV charging assist control is supplied to the six assembled storage batteries 41 to 4n constituting the second storage battery group, and the process proceeds to step S55. By the processing of step S53, the charging processing is performed in the region F3.

In step S55, it is determined whether the equalizing charging has been completed. When it is determined that the equalizing charging has been completed, the process of the equalizing charging operation is ended. On the other hand, when the equalizing charging is not completed, the process proceeds to step S50. In the determination of the end of the equalizing charging, for example, an end condition in which the time of CV charging is equal to or longer than a threshold value, the charging current is equal to or less than a threshold value, or the charging rate is equal to or higher than a threshold value is set, and when it is determined that the end condition is satisfied, it is determined that the equalizing charging has been ended.

In step S54, a command for maximum charging is supplied to the six assembled storage batteries 41 to 4n constituting the first storage battery group, and a command for surplus power charging is supplied to the six assembled storage batteries 41 to 4n constituting the second storage battery group, and the process proceeds to step S50. By the processing of step S54, the charging processing is performed in the region F2.

Others

The present disclosure can also include the following configurations.

(1) A power storage system includes: a plurality of assembled storage batteries each configured by electrically connecting a plurality of storage batteries; a plurality of AC-DC converters provided for each of the assembled storage batteries and electrically connecting an external power supply system including rotary machine power generation and solar power generation to the assembled storage batteries; a plurality of individual assembled storage battery management units provided for each of the assembled storage batteries and configured to manage states of the assembled storage batteries and control the AC-DC converters to charge and discharge the assembled storage batteries; an upper assembled storage battery management unit configured to acquire a state of each of the assembled storage batteries from the plurality of individual assembled storage battery management units and supply a charge/discharge command to each of the individual assembled storage battery management units; and an equalizing charging necessity determination unit configured to determine whether or not equalizing charging needs to be performed; wherein the upper assembled storage battery management unit includes: a charge processing unit configured to control an operation of charging the plurality of assembled storage batteries with surplus power in daytime generated by the solar power generation and the rotary machine power generation; and a discharge processing unit configured to control an operation of discharging the plurality of assembled storage batteries according to insufficient power generation by the rotary machine power generation, and when the equalizing charging necessity determining unit determines that the equalizing charging needs to be performed, the charge processing unit performs control for an equalizing charging operation on one or two or more of the assembled storage batteries selected from the plurality of assembled storage batteries by using the surplus power.

(2) The plurality of assembled storage batteries are divided into a plurality of storage battery groups, and when the equalizing charging necessity determination unit determines that equalizing charging needs to be performed, the charge processing unit performs control for the equalizing charging operation on a storage battery group selected from the plurality of storage battery groups.

(3) When the charge processing unit determines that there is a margin in the surplus power during CV charging as the equalizing charging operation on the selected storage battery group at time of performing control for the equalizing charging operation on the selected storage battery group, the charge processing unit performs a charging/discharging operation on a storage battery group selected from the storage battery groups other than the selected storage battery group with the surplus power corresponding to the margin.

(4) An equalizing charge method includes performing an equalizing charging operation on one or two or more assembled storage batteries selected from a plurality of assembled storage batteries at time of charging with surplus power when it is determined that equalizing charging is required in a power storage system in which the plurality of assembled storage batteries connected to an external power supply system including rotary machine power generation and solar power generation are charged with the surplus power in daytime generated by the solar power generation and the rotary machine power generation to store the surplus power and are discharged according to insufficient power generation by the rotary machine power generation to handle the insufficient power generation.

(5) The plurality of assembled storage batteries are divided into a plurality of storage battery groups, and when it is determined that the equalizing charging needs to be performed, the equalizing charging operation is performed on a storage battery group selected from the plurality of storage battery groups.

(6) When it is determined that there is a margin in the surplus power during CV charging as the equalizing charging operation on the selected storage battery group at the time of performing the equalizing charging operation on the selected storage battery group, a charging/discharging operation is performed on a storage battery group selected from the storage battery groups other than the selected storage battery group with the surplus power corresponding to the margin.

Although herein the description is given with reference to a limited number of embodiments, the scope of right is not limited thereto, and modifications of each embodiment based on the above disclosure are self-evident to those skilled in the art.

The following is a list of reference signs used in this specification and in the drawings.
1 upper BMU (upper assembled storage battery management unit)
1Da charge processing unit
1Db discharge processing unit
21 to 2n individual BMU (individual assembled storage battery management unit)
31 to 3n PCS (AC-DC converter)
41 to 4n assembled storage battery
5 assembled storage battery sensor
6 EMS (equalizing charging necessity determination unit)

What is claimed is:

1. A power storage system comprising:
a plurality of assembled storage batteries each configured by electrically connecting a plurality of storage batteries;
a plurality of AC-DC converters provided for each of the assembled storage batteries and electrically connecting an external power supply system including rotary machine power generation and solar power generation to the assembled storage batteries;
a plurality of individual assembled storage battery management units provided for each of the assembled storage batteries and configured to manage states of the assembled storage batteries and control the AC-DC converters to charge and discharge the assembled storage batteries;
an upper assembled storage battery management unit configured to acquire a state of each of the assembled storage batteries from the plurality of individual assembled storage battery management units and supply a charge/discharge command to each of the individual assembled storage battery management units; and
an equalizing charging necessity determination unit configured to determine whether or not equalizing charging needs to be performed; wherein the upper assembled storage battery management unit includes:
a charge processing unit configured to control a charging operation of charging the plurality of assembled storage batteries with surplus power in daytime generated by the solar power generation and the rotary machine power generation; and
a discharge processing unit configured to control an operation of discharging the plurality of assembled storage batteries according to insufficient power generation by the rotary machine power generation, and
when the equalizing charging necessity determining unit determines that the equalizing charging needs to be performed, the charge processing unit performs control for an equalizing charging operation on one or two or more of the assembled storage batteries selected from the plurality of assembled storage batteries by using the surplus power.

2. The power storage system according to claim 1,
wherein the plurality of assembled storage batteries are divided into a plurality of storage battery groups, and
when the equalizing charging necessity determination unit determines that equalizing charging needs to be performed, the charge processing unit performs control for the equalizing charging operation on a storage battery group selected from the plurality of storage battery groups.

3. The power storage system according to claim 2,
wherein when the charge processing unit determines that there is a margin in the surplus power during CV charging as the equalizing charging operation on the selected storage battery group at time of performing control for the equalizing charging operation on the selected storage battery group, the charge processing unit performs a charging/discharging operation on a storage battery group selected from the storage battery groups other than the selected storage battery group with the surplus power corresponding to the margin.

4. An equalizing charge method comprising performing an equalizing charging operation on one or two or more assembled storage batteries selected from a plurality of assembled storage batteries at a time of charging with surplus power when it is determined that equalizing charging is required in a power storage system in which the plurality of assembled storage batteries connected to an external power supply system including rotary machine power generation and solar power generation are charged with the surplus power in daytime generated by the solar power generation and the rotary machine power generation to store the surplus power and are discharged according to insufficient power generation by the rotary machine power generation to handle the insufficient power generation.

5. The equalizing charge method according to claim 4,
wherein the plurality of assembled storage batteries are divided into a plurality of storage battery groups, and when it is determined that the equalizing charging needs to be performed, the equalizing charging operation is performed on a storage battery group selected from the plurality of storage battery groups.

6. The equalizing charge method according to claim 5,
wherein when it is determined that there is a margin in the surplus power during CV charging as the equalizing charging operation on the selected storage battery group at the time of performing the equalizing charging operation on the selected storage battery group, a charging/discharging operation is performed on a storage battery group selected from the storage battery groups other than the selected storage battery group with the surplus power corresponding to the margin.
